(19) United States
(12) Patent Application Publication
(10) Pub. No.: US 2006/0288233 A1
(43) Pub. Date: Dec. 21, 2006

(54) Attachable biometric authentication apparatus for watchbands and other personal items

(76) Inventor: Douglas Kozlay, Timonium, MD (US)

Correspondence Address: DOUGLAS KOZLAY, SUITE 304, 9475 DEERCO ROAD, TIMONIUM, MD, 21093, US

(21) Appl. No.: 11/113,572

(22) Filed: Apr. 25, 2005

(51) Int. Cl. H04K 1/00

(52) U.S. Cl. 713/186

(57) ABSTRACT

The “first apparatus” disclosed is an ergonomic, removably-attachable biometric user authentication module, attachable onto a wristwatch band (or other surface) directly proximate to a user. This first apparatus includes (1) an attaching subsystem (e.g., bendable tabs, Velcro™ straps, etc.); and (2) a biometric authentication subsystem module. The first apparatus attaches onto any convenient “target” surface, but wristwatch bands are ideal for many users. The invention method, is a secure wireless protocol for communicating “successful biometric authentication” messages from the first apparatus, to a verification transceiver/reader (a “second apparatus”) which grants or denies user(s) access to transaction(s) and/or controlled resource(s), facilities, etc. The transceiver/reader is an “access governance” device that ensures only authorized users can access controlled (e.g., financial, physical, logical, etc.) resources. The system of the invention combines these first and second apparatuses and this method, plus includes embedded software for granting user access to controlled resources.

### BACKGROUND OF THE INVENTION

1. Field of the Invention

The present Invention relates to biometric user authentication devices. More particularly, the Invention relates to controlling access to: (a) financial transactions (credit, debit, or other payment applications); and/or (b) physical access transactions (doors, locks, etc.); and/or (c) “logical access transactions” (computers, PCs, etc.); and/or other applications benefited by biometric user identification.

More particularly, the Invention relates to a “removably-attachable” device—e.g., a clip-on, strap on, buckle-on, bend-on, etc., apparatus—that's attachable to a band or a strap of a wristwatch (or other attachment surface). The apparatus relates to a device with a self-contained biometric authentication capability, plus, contactless radio frequency transmission capability. The biometric user authentication capability prevents initiation of transactions and/or initiation of access requests by anyone other than the authenticated, enrolled user whose fingerprint can be authenticated.

2. Related Art

There appears to be no directly related art. Although a variety of biometric authentication devices are well known in the art, there appears to be no invention similar to the present invention.

### NECESSITY OF THE INVENTION

“Contactless” electronic commerce devices often require a person to locate—then remove—an authenticator, key fob or other radio-frequency electronic token from pocket (or purse, or attaché case, etc.) in order to make a financial transaction.

Accessing and handling a biometric user authentication device that's attached onto the wrist (e.g., onto a watchband, bracelet, swatch) or attached onto any other directly-proximate attachment surface (e.g., a belt, a belt-loop, an epaulet or other flap, etc.) is sometimes much quicker, more convenient, and more ergonomic than searching for and/or retrieving other access devices (smart cards, key fobs, etc.) authenticators from a pocket or purse.

Accordingly, there is a need in the art for an invention that provides an apparatus, method, and a system for improving and simplifying user control of, deployment of, and usage of their biometric user authentication device, while increasing ergonomics and convenience to the user. Although there are many biometric devices in the art, there appears to be no device that provides diverse “attachable” deployment options directly proximate to the user, without the user having to resort to “retrieval” efforts.

### OBJECTS OF THE INVENTION

Accordingly, it is a primary object of the invention, to provide a biometrically enabled apparatus which is attachable (e.g., clipped-on, strapped-on, snapped-on, etc.) to any attachment surface (typically, a watchband) or other convenient personal item.

It is a related object, to provide a biometrically enabled apparatus for controlling user access to controlled resources—e.g., to prospective financial transaction(s), physical access, logical access, etc. In the case of (e.g.) financial transactions made at ATM machines after biometric authentication, the apparatus generates, sends, and receives messages in financial transactions-oriented message formats, then closes the transaction by wirelessly executing an “ATM money withdrawal agreement”.

It is a related object, to provide a “removably attachable” biometrically enabled user authentication device equipped with one or more of a fingerprint sensor, an iris sensor, another biometric sensor (or other non-biometric user authentication mechanism) which is easily attached to (and easily removed from) a watch band (or other convenient “attachment surface” that's directly proximate or essentially proximate to the user).

Another related object—after the user is authenticated as being the authorized account holder—is to provide a device which cryptographically protects transactions transmitted by radio between the removably attachable user authentication apparatus and a verification transceiver/reader coupled to (e.g.) point of sale equipment associated with making one or more transaction(s).

### SUMMARY OF THE INVENTION

The present invention provides a payment mechanism and/or access control mechanism that only requires the person making the payment transaction—and/or seeking access to a controlled resource—to press a fingerprint sensor button on a biometric user authentication apparatus. The present invention is conveniently and ergonomically “attached” (by clipping on, or strapping on, or belting on, or snapping-on, etc.) to a watchband or other user-proximate “attachment surface”. This allows the user to first authenticate their identity—then wirelessly communicate and interact with a verification/reader—then (e.g.) subsequently verify and accept the sale (in the case of a prospective financial transaction).

Watchbands are an ideal “attachment surface” target for the apparatus of the present invention (although attachment surface targets are not limited to watchbands). More particularly, some watches have been outfitted with radio frequency transmitters or transceivers that can communicate with point of sale (POS) terminals to initiate and/or authenticate transactions—however—they depend upon the wearer of the watch being the authorized account holder. If a “bearer device”—such as a watch-based authentication device—is lost or stolen, it presents a risk because a watch thief can make transactions by using the watch (at least until the account has been closed). Fraudulent transactions that are made in this way are either charged to the account holder or to the bank, depending upon the governing credit agreement. Even in cases where the loss is charged to the bank, the aggregate amounts are covered by increasing monthly fees to merchants and account holders.

One primary feature of the invention is its' attachability. There are many different ways the invention can be “removably attached” onto a surface directly proximate to a user that is immediately at hand to the user. While the watchband is often optimal for many users, other typical attachment surfaces are belt-loops, so-called “epaulets” (flaps on clothing), button holes, etc. Also the attachment means can be Velcro™ straps; bungee type straps; snap-together straps; belt-type straps; etc.

The present invention also contributes to increasing security, because it facilitates keeping the biometric user authentication device within the instant possession of the wearer and under the wearer's control as opposed, for example, to being lost in the depths of a handbag, a purse, an attaché case or other carrying device.

The “first apparatus” of present invention is a clip-on user-authentication apparatus which is typically attached onto the strap of a wristwatch (or the like). Primary components of the first apparatus: (1) a clip-on attaching subsystem such as a Velcro™ strap or other attaching means; and (2) a mobile, integrated biometric authentication subsystem module. The strap is user-adjustable and is adjusted to securely affix the first apparatus to a “target” wristwatch strap (or any accessible, “attachment surface” which is easily and directly proximate to the user). The module is inserted and/or affixed onto the attaching subsystem, generally into an insertion aperture especially dimensioned to receive the module. The module is easily inserted and/or affixed into the attaching strap means, due to mounting flanges which protrude outboard of the module.

In further summary of the ergonomics and convenience of the invention, it can be widely observed that many people wear wrist watches and/or other electronic and non-electronic personal “auxiliaries” on their left and/or right wrist(s). While wristwatch straps are among the most optimal “target devices” for the present invention, other wrist-worn personal articles can work fine, as well. Other convenient, “directly proximate” attachment surfaces provide many other suitable surface(s) for affixing the “first apparatus”—(the integrated biometric authentication module subsystem and attaching subsystem of the present invention)—thereto.

The mobile, integrated biometric authentication subsystem module is generally designed, configured and implemented as an autonomous, wireless transceiver which transmits “biometric authentication successful” data messages to a destination transceiver monitoring for data message evidence of successful biometric authentication.

The method of the invention is a protocol for securely communicating “successful biometric authentication” data messages from this first apparatus, to a “second apparatus”, e.g., a verification transceiver/reader (“the second apparatus”) which grants or denies a biometrically-authenticated user's access to a proposed transaction, and/or grants access to controlled resource(s), controlled facilities, etc. The second apparatus of the invention (the verification transceiver) is an “access governance” device that monitors controlled access location(s) and/or any other controlled (e.g., financial, physical access, etc.) transaction.

The system of the invention combines the first and the second apparatuses and the method, plus embedded software in both apparatuses to enable and effectuate access for biometrically-authenticated users.

### DETAILED DESCRIPTION OF THE INVENTION

### Brief Description of Figures and Reference Numerals

### BRIEF DESCRIPTION OF FIGURES

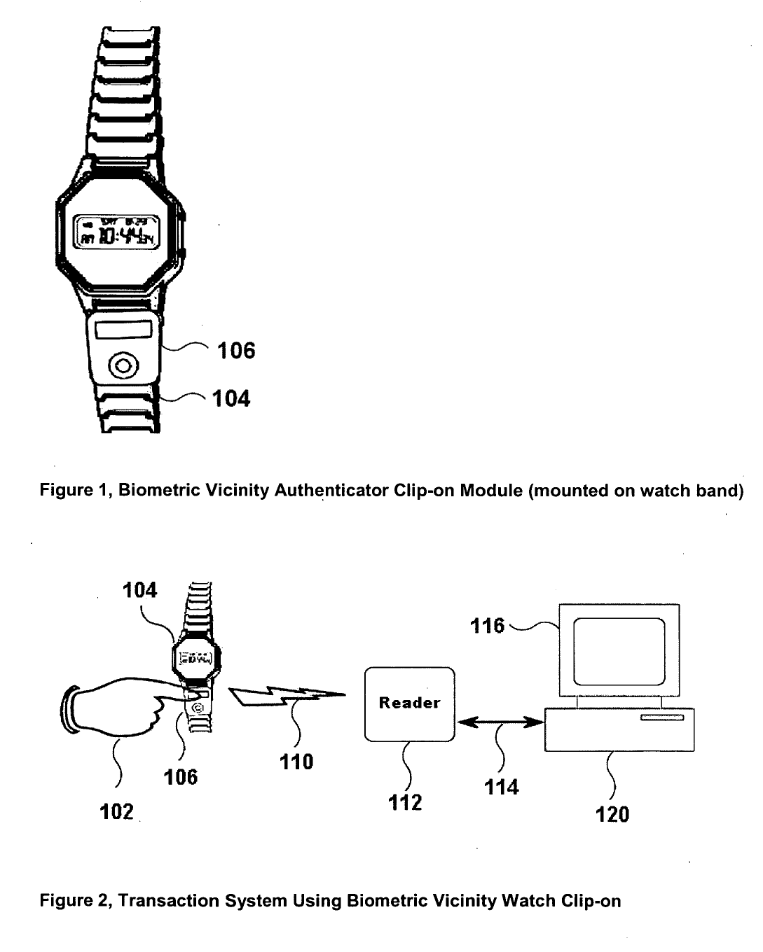

FIG. 1, Biometric “Vicinity Authenticator” (Clip-on) Module, attached to a wristwatch band

FIG. 2, System: User; Authenticator Module (clipped on); Wireless Signal; Signal Reader

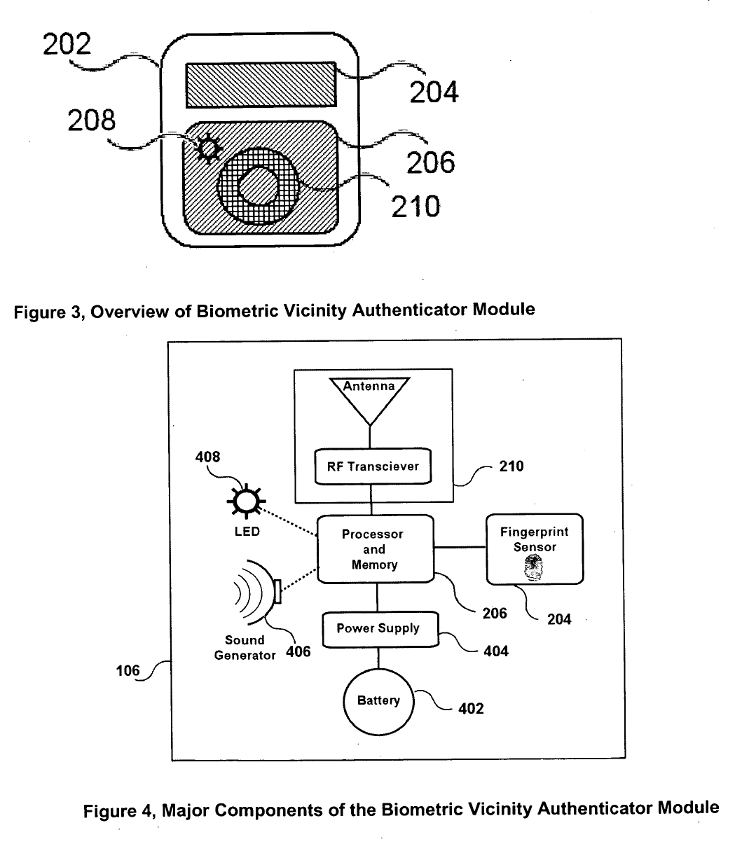

FIG. 3, General Components of Biometric Vicinity Authenticator Module

FIG. 4, Overview of Circuit Components of Biometric Vicinity Authenticator (Clip-on) Module

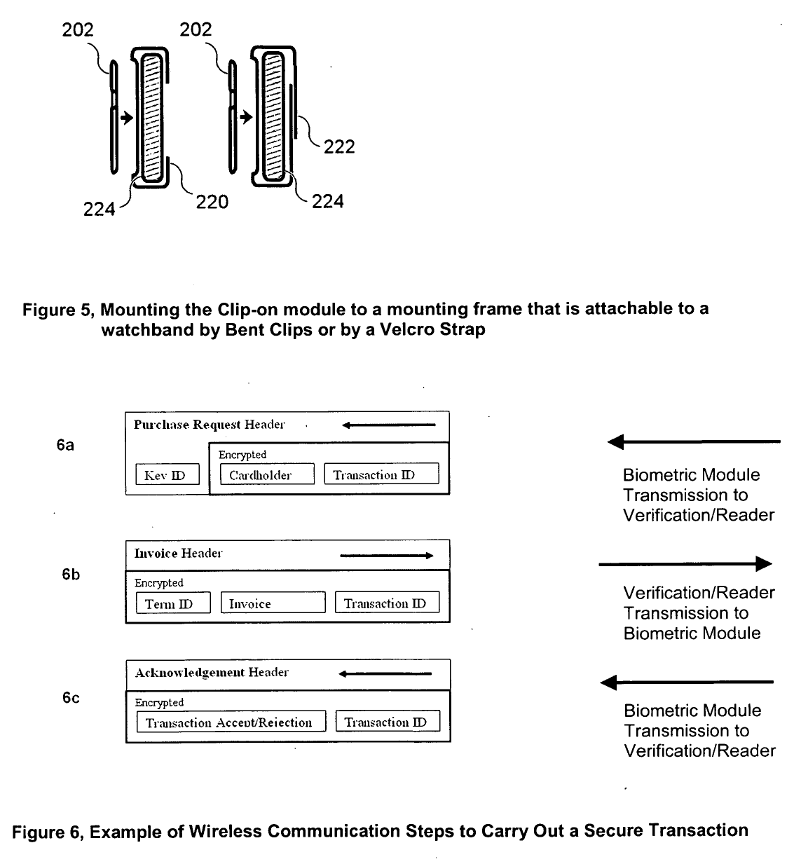

FIG. 5, Mounting a removably-attachable Biometric Module to a mounting frame that is attachable to a watchband by Bent Clips or by a Velcro Strap

FIG. 6, Example of Wireless Communication Steps to Carry Out a Secure Transaction

### REFERENCE NUMERALS

102 Hand and index inger, with enrolled fingerprint placed onto sensor
104 Wristwatch with watch strap or wrist band (or other attachment surface)
106 Biometric Vicinity Authenticator Module (front view, FIG. 3; edge view, FIG. 5)
110 Wireless radio data message from module 106 to verification/reader 112
112 Verification/Reader, including radio transceiver and computer interface
114 Data path from verifireader to transaction terminal
116 Display unit of a transaction terminal
120 Transaction terminal
202 Substrate for mounting electronic components of module 106
204 Fingerprint sensor
206 Processor to perform on-device biometrics and secure communications
208 Optional LED light and noise generator to indicate successful authentication
210 Radio transceiver and antenna
220 Clip-on attaching subsystem frame with bendable tabs
222 Strap-on attaching subsystem frame with Velcro™ strap
224 Watchband 104 shown in cross section
402 Battery
404 Power supply
406 Optional sound generator, to indicate successful authentication
408 Optional LED light to indicate successful authentication

FIG. 1 shows “removably-attachable” biometric “vicinity authenticator” module 106, mounted (using bendable “clip-on” tabs, Velcro™ straps, etc) onto a typical wristwatch band 104 (or other suitable attachment surface). More generally, the biometric vicinity authenticator module 106 is attached onto any convenient “attachment surface” easily reached by the user's finger(s) to very quickly authenticate themselves upon demand—using one or more of the user's enrolled fingerprint(s).

FIG. 2 shows an overview of the system of the invention. A user presents their hand and finger 102 for authentication by the fingerprint sensor embedded into removably-attachable biometric authentication module 106 (which is strapped onto a wristwatch band 104). NB: The integrated module 106 is also referred to as the “first apparatus” of the invention. The authenticated user—after successful completion of biometric (e.g., fingerprint) authentication—and while using module 106—generates and wirelessly transmits a “successful biometric authentication completion” data message 110 to the “second apparatus” of the invention, the verification transceiver/reader 112. The reader 112 is essentially an “access governance apparatus” for limiting and controlling user access to one or more controllable resources. In this case, the data path 114 connects the verification transceiver/reader 112 to one or more controlled resources—e.g., in this case, computer 120—to which the user seeks access. After the user biometrically authenticates, and the module 106 transmits the data message 110, the transceiver/reader 112 receives and verifies that then message 110 is genuine. If the transceiver/reader 112 verifies message 110, then the user is granted access to computer 120. In the case illustrated, the results of the user's biometric authentication (the sending of the successful biometric authentication completion message) and the verification by the transceiver/reader 112 (that message 110 is genuine and that the user is granted access) can be displayed by the computer 120 visually on display 116 and/or audibly by the computer's sound generator.

After the user successfully completes biometric authentication, radio communications capabilities are enabled long enough to send a “successful biometric authentication completion message” from module 106 to verification transceiver/reader 112, plus the enabled radio link may communicate one or more additional messages to complete a prospective transaction (e.g., permit access to a computer or facility). (See also FIG. 6, showing a financial transaction such as a purchase transaction). In general, module 106 is only enabled by an enrolled, authorized user presenting one or more “biometric credentials”, e.g., their enrolled fingerprint(s) onto fingerprint sensor 204. This basic technique is well-known in the art of biometric fingerprint authentication (e.g. such as disclosed in U.S. Pat. No. 4,582,985 to Lofberg), i.e., if the presented fingerprint is authenticated and verified as an enrolled fingerprint, sensor 204 generates and sends an actuating (enabling) signal (signifying “successful biometric authentication completed”) to processor 206, thereby enabling all implemented module 106 functions.

Referring now to FIG. 3, an external overview of the biometric authentication subsystem module 106 of the present invention is shown. The module 106 as a whole is implemented onto and/or into a suitable enclosure and/or substrate 202. Module 106 performs fingerprint authentication (data processing, memory storage/retrieval, and other inherent functions) by means of its' embedded integral data processor 206 operating in conjunction with fingerprint sensor 204. Also shown are light emitting diode 208 and radio transceiver and antenna 210. Alternatively (variously, depending on configuration, implementation, and need) one or more processors could be implemented in the same common data processor (e.g., as described by U.S. Pat. No. 6,474,558 to Reiner, described herein).

FIG. 4 shows an overview of a typical electronic circuit of the biometric user authenticator module 106 of the present invention. The authenticator module 106 is also known as the “biometric authentication subsystem module”. A data processor 206 including a memory is coupled into a biometric authentication sensor such as a fingerprint sensor 204 (shown), an iris sensor (not shown), other types of biometric sensor (not shown), or other non-biometric sensor (not shown). The processor 206 is also optionally coupled (when implemented) to either a light emitting diode 408 (shown) and/or coupled to an acoustic generator 406 (shown) which allows the biometric vicinity authenticator module 106 to produce an audible acoustic “successful biometric authentication completion” cue and/or a visual lit LED cue, that a prospective user has successfully biometrically authenticated. Further, it may be assumed that after the user has successfully authenticated and one or more acoustic and/or visual completion cues are present, then the “successful biometric authentication completion” data message 110 will be transmitted out from module 106. The means for generating the radio-transmitted completion message 110 include the processor and its' memory. The means for transmitting the generated data message 110 are the radio transceiver and antenna 210. Optionally, the transmission of completion message 110 can be cryptographically protected by encryption.

Electrical power for operating all the electronics of module 106 is a power source; in this case, the power source is a battery 402 coupled to a power supply 404. Typically, the module 106 contains all the electronics needed to electronically enable the present invention. On the exterior of the module 106, typically flanges or other external supporting structure are included and protrude outside of module carrier comprising the enclosure. Such flanges (not shown) or other support structure(s) assist in balancing, affixing, and inserting the module 106 into an insertion aperture or module mounting location within the attaching subsystem. The integrated first apparatus of the invention comprises (1) the attaching subsystem which (2) generally embeds the biometric authentication subsystem module 106 thereinto (i.e., into the straps, clip-ons, buckles, etc., used for attaching and removing the removably attachable invention onto and off of an attachment surface.

FIG. 5 shows two different versions (of the many attachment versions possible) of the attaching subsystem 224 of the invention. Substrate 202 comprises a substrate including module 106, which together are mounted into an insertion aperture or module “mounting area” in attaching subsystem 224. On the left side of FIG. 5, bendable tabs or clip-ons 220 provide attaching subsystem 224. On the right side of FIG. 5, Velcro™ straps provide attaching subsystem 224, which can easily be attached onto a watchband strap or other suitable attachment surface, and then removed at any time. Hence, these versions of attaching subsystem 224 (and others) are observed as enabled to be “removably attachable”; therefore, one way we refer to the first apparatus of present invention herein, is “the removably attachable biometric vicinity authenticator apparatus”.

Additionally, the integrated first apparatus of the invention—including authentication subsystem module and the attaching subsystem—can be referred to as a “biometric vicinity authenticator apparatus”, because it can be easily attached and removed from any appropriate “target” attachment surface proximate to the user, which in turn, allows the user to very quickly authenticate themselves to the module 106.

It must also be noted that other attaching subsystem appurtenances can be used for removably attaching the first apparatus of the present invention to any appropriate-sized attachment surface that's adequately proximate to the user that can be quickly accessed for authentication (e.g.: a “bungee cord” or strap; a shoelaces-type strap; a tie-wrap style strap; a buckle type strap; a belt; a swatch-style strap; a snap; etc.).

FIG. 6 shows one typical interaction between the “first apparatus” of the invention (the removably-attachable biometric vicinity authenticator module 106) and the “second apparatus” of the invention (the verification/reader 112). The transaction depicts a purchase by a user, at a verification/reader apparatus, beginning in FIG. 6A, wherein the user first authenticates themselves to the integrated module 106 (which in this reference case, is attached onto watchband 104). Having successfully completed biometric authentication, module 106 generates and transmits a “successful biometric authentication completion” data message 110 to the verification transceiver/reader 112 (not shown). Assuming biometric authentication is complete, FIG. 6A shows the general message format of a “Purchase Request Header”, sent by module 106 of the user's biometric authenticator apparatus (the “first apparatus”), to the verification transceiver/reader 112 (the “second apparatus”). FIG. 6B shows an Invoice Header sent by the verification transceiver reader 112, back to module 106. FIG. 6C shows an Acknowledgment Header send by the module 106, back to the reader 112. This is a quick summary of an purchase transaction. Wireless transactions of many types are possible with the present invention, not just ATM transactions or purchase transactions. It should be noted, that disclosures herein are only basic examples of customizability and the capabilities of this invention. It can be readily understood that diverse other equipment configurations and other operational scenarios can be implemented. It is also important to note, when a verification transceiver/reader such as reader 112 has a biometric authentication capability, it may not be necessary to biometrically authenticate using the apparatus of the present invention at each access point; however, in such a case, it may additionally be necessary to configure the verification transceiver reader to send a command to the present invention to enable the radio functions, but only after the prospective user has been successfully biometrically authenticated. It must also be noted, that those skilled in the art will be able to read the disclosures taught herein and contemplate other applications of the present invention and other configurations of the present invention which, while not explicitly disclosed herein, are effectively and implicitly disclosed herein. Accordingly, the scope of this invention is not limited only by the specification, drawings, and claims provided herein.

I claim:

1. A removably-attachable user authentication apparatus for authenticating at least one enrolled user, comprising:
an attaching subsystem for attaching said apparatus to an attachment surface; and
a biometric authentication subsystem module.

2. The apparatus of claim 1, wherein said attaching subsystem further comprises means for removably attaching said user authentication apparatus to any attachment surface accessible to said at least one enrolled user, and wherein said attaching subsystem further comprises at least one of a Velcro™ strap and a clip-on strap and a belt-type strap and a bendable tab and a bungee-type strap and a tie-style strap and a tie-wrap-style strap.

3. The apparatus of claim 1, wherein said attaching subsystem further comprises an installation aperture for inserting and mounting said biometric authentication subsystem module thereinto.

4. The apparatus of claim 1, wherein said biometric authentication subsystem module further comprises mounting flanges for mounting said module into at least one of an installation aperture and a module mounting area disposed within said attaching subsystem.

5. The apparatus of claim 1, wherein said biometric authentication subsystem module further comprises at least one biometric authentication circuit including at least one processor coupled to a biometric authentication sensor, a transceiver with an antenna, and a power source including a battery and a power supply.

6. The biometric authentication subsystem module of claim 1, further comprising a fingerprint sensor.

7. The biometric authentication subsystem module of claim 1, further comprising an iris sensor.

8. An access governance apparatus comprising a second apparatus and further comprising a verification transceiver/reader including a transceiver for communicating with at least one removably attachable biometric user authentication apparatus comprising a first apparatus.

9. The apparatus of claim 8, further comprising at least one of a contact verification transceiver/reader apparatus and a contactless verification transceiver/reader apparatus.

10. The apparatus of claim 8, further comprising at least one of a smartcard reader apparatus and a token reader apparatus.

11. A method for securely transmitting a successful biometric authentication completion message from a first apparatus comprising a removably attachable biometric user authentication device, to a second apparatus comprising an access governance device for governing access to at least one controlled resource, comprising the steps of:
biometrically enrolling at least one user into said first apparatus;
issuing said first apparatus to said at least one user;
attaching said first apparatus to an attachment surface;
enabling said first apparatus by said at least one user, only after successful biometric authentication completion by said at least one user by said first apparatus;
generating a successful biometric authentication completion message in said first apparatus;
transmitting said successful biometric authentication completion message from said first apparatus to said second apparatus;
receiving in said second apparatus, said successful biometric authentication completion message transmitted by said first apparatus;
verifying in said second apparatus said successful biometric authentication completion message;
transmitting a verification message from said second apparatus to said first apparatus, only after verifying that said successful biometric authentication completion message is genuine; and
granting access to said at least one user and said first apparatus, to said at least one controlled resource coupled to said second apparatus, wherein said access is granted by said second apparatus.

12. The method of claim 11, wherein said step of transmitting said successful biometric authentication completion message is followed by generating and transmitting financial transactions messages in a financial transaction oriented message format.

13. The method of claim 11, wherein said step of transmitting said successful biometric authentication completion message comprises the additional step of cryptographically protecting said message.

14. The method of claim 12, wherein said generated and transmitted financial transactions messages include the additional step of cryptographically protecting said financial transactions messages.

15. A system for communicating a successful biometric authentication completion message from a first apparatus comprising a removably attachable user authentication device, to a second apparatus comprising an access governance device for controlling access to at least one controlled resource coupled thereto, comprising:
at least one method for transmitting said successful biometric authentication completion message from said first apparatus to said second apparatus;
said first apparatus comprising said removably attachable user authentication device;
at least one enrolled user;
said second apparatus comprising said access governance device coupled to said at least one controlled resource; and
said at least one controlled resource.

16. The system of claim 15, wherein biometric authentication is performed by at least one of a fingerprint sensor and an iris sensor.

17. The biometric authentication subsystem of claim 1, further comprising embedded software instructions executing on at least one data processor for determining whether to grant or deny access to a controlled resource by a user.

18. The access governance apparatus comprising the verification transceiver/reader of claim 8, further comprising embedded software instructions executing on at least one data processor for determining whether to grant or deny access to a controlled resource by a user.

19. The apparatus of claim 1, wherein said attaching subsystem further comprises means for removably attaching said user authentication apparatus to any attachment surface directly proximate to said at least one enrolled user, and wherein said attaching subsystem further comprises at least one of a Velcro™ strap and a clip-on strap and a belt-type strap and a bendable tab and a bungee-type strap and a tie-style strap and a tie-wrap-style strap.
